(19) United States
(12) Patent Application Publication
(10) Pub. No.: US 2012/0004792 A1
(43) Pub. Date: Jan. 5, 2012

(54) Weber-box, an aviation display device to support spatial awareness

(75) Inventors: Axel Weber, Ponitz (DE); Michael Erian McCauley, Carmel-by-the-Sea, CA (US)

(73) Assignee: The United States of America as represented by the Secretary of the Navy

(21) Appl. No.: 11/973,994

(22) Filed: Sep. 28, 2007

(51) Int. Cl. G06F 17/00

(52) U.S. Cl. 701/9; 701/4

(57) ABSTRACT

A method for displaying information to a pilot or operator of a manned or unmanned aerial vehicle to facilitate safe operation of the aerial vehicle includes the steps of providing a display screen, displaying a three dimensional Cartesian coordinate system having a horizontal axis, a vertical axis and a depth axis on the display screen, displaying a model of an aerial vehicle on the screen in a manner that represents the position and velocity of the aerial vehicle relative to the coordinate system, displaying the horizontal axis and the vertical axis in a selected manner to indicate a potentially unsafe condition and providing an altitude display near the vertical axis. The display screen provides warnings to indicate unsafe conditions of altitude and pitch angle and includes objects that represent the ground. The ground objects move on the screen to indicate the speed and direction of the aerial vehicle.

### BACKGROUND OF THE INVENTION

This invention relates generally to aviation and particularly instrumentation for flight control. Still more particularly, this invention relates to an improved flight control display for use by pilots and operators of both manned and unmanned aerial vehicles.

Pilots and operators of manned and unmanned aerial vehicles must constantly maintain a three dimensional mental picture of the current spatial situation of the aircraft. If this spatial awareness is degraded, the safety of the flight is at risk. Even a temporary loss of awareness of the spatial situation can cause loss of control of the aerial vehicle. Historically degraded spatial awareness is responsible for about 25% of all fatal flight accidents for the past twenty years.

The state of flight design has been based design principles that have been almost unchanged for over seventy years. Traditional flight instrument displays are difficult to interpret, especially under conditions of reduced visibility, high workload and stress. Under circumstances of reduced spatial awareness current flight instrument displays may lead to control reversals and faulty flight maneuvers.

Traditional flight instrument displays utilize an egocentric viewpoint with a fixed aircraft model and a moving horizon indicator. Furthermore, these flight instrument displays decompose the actual spatial attitude of the aircraft into separated values of pitch, roll, yaw, heading, airspeed and altitude. These values are usually represented by a number of different instruments or displays.

### SUMMARY OF THE INVENTION

The major objective of the present invention is to support the spatial awareness of an operator or pilot of an aerial vehicle in an easily understand able and intuitive way that overcomes problems associated with traditional flight instrument displays.

Because current display design has inherited many poor design features through its historical roots, the present invention introduces a new way to represent the major elements of flight dynamics. An objective of this invention is to provide a unique, innovative way to display spatial information in flight instruments. The instrument display according to the present invention is not designed to substitute for any of the traditional instruments. Rather, the present invention supports the operator of an aircraft in extreme or ambiguous situations by providing the appropriate level of spatial awareness that is intuitively understood.

To accomplish these goals, as many of the design guidelines, principles, and ideas for human-centered display design are implemented as are appropriate and pertinent. The main principle involved is to support the operator's mental model of the spatial behavior of the aircraft. An objective of the invention is to support the highest level of spatial awareness and project an immediate situation into the future.

A method according to the present invention for displaying information to a pilot or operator of a manned or unmanned aerial vehicle to facilitate safe operation of the aerial vehicle comprises the steps of providing a display screen, displaying a three dimensional Cartesian coordinate system having a horizontal axis, a vertical axis and a depth axis on the display screen, displaying a model of an aerial vehicle on the screen in a manner that represents the position and velocity of the aerial vehicle relative to the coordinate system, displaying the horizontal axis and the vertical axis in a selected manner to indicate a potentially unsafe condition and providing an altitude display near the vertical axis.

The method according to the present invention may further comprise the steps of providing a safe altitude reference element that gives a visual indication when the aerial vehicle is at a safe altitude and providing a below safe altitude reference element that gives a visual indication when the aerial vehicle is at an unsafe altitude.

The method according to the present invention may additionally further comprising the step of providing a plurality of ground objects in a horizontal plane that represent a portion of the earth over which the aerial vehicle is flying. The ground objects preferably move in the horizontal plane at a speed and a direction that represent the speed and direction of the aerial vehicle relative to the earth. The ground objects preferably are displayed in a selected color when the aerial vehicle is below a selected safe altitude. The ground objects preferably are displayed to have dimensions that represent the altitude of the aerial vehicle.

The method according to the present invention may further comprise the step of displaying a longitudinal axis line of the aerial vehicle in a first selected manner to indicate that the aerial vehicle has a positive pitch angle and displaying the longitudinal axis line in a second selected manner to indicate that the aerial vehicle has a negative pitch angle.

### BRIEF DESCRIPTION OF THE DRAWINGS

FIG. 1 illustrates an instrument display according to an embodiment of the present invention.

FIG. 2 illustrates the instrument display of FIG. 1 showing a topside view of an aircraft model;

FIG. 3 illustrates the instrument display of FIG. 1 showing a bottom side view of an aircraft model;

FIG. 4 illustrates an instrument display panel according to the present invention representing an aircraft or aerial vehicle in level flight;

FIG. 5 represents an aircraft making a left turn;

FIGS. 6 and 7 represent examples of an aircraft where objects representing the ground indicate a critical altitude; and

FIG. 8 is a block diagram representing a system that provides data to be displayed on the instrument display.

### DETAILED DESCRIPTION OF THE INVENTION

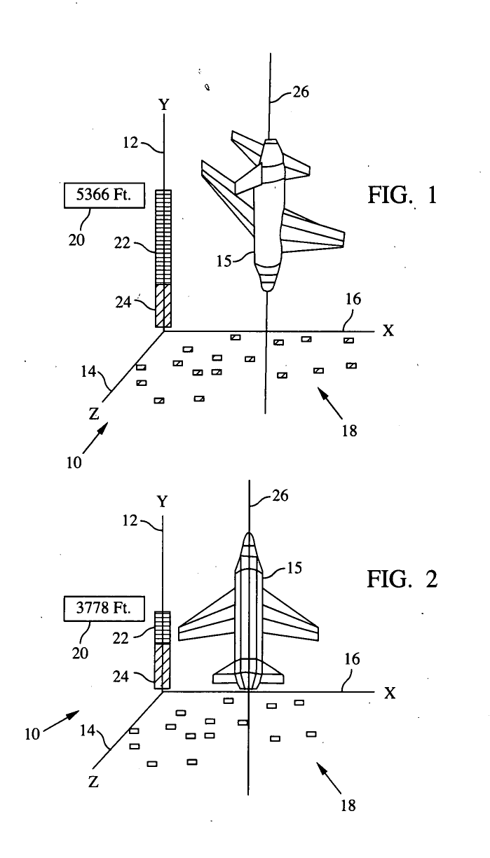

FIG. 1 illustrates an instrument display 10 according to an embodiment of the present invention. The display 10 may be comprised of a cathode ray tube, a light emitting diode array, liquid crystal array or other suitable apparatus for visually displaying information. In this embodiment there is Cartesian coordinate system having a vertical axis reference 12, a depth axis reference 14, and a horizontal axis reference 16. One purpose of these reference axes is to provide a visual-spatial reference for the vertical, depth, and horizontal spatial orientation of an aircraft 15 or aerial vehicle such as an Unmanned Aerial Vehicle (UAV). Although this description of the invention will subsequently refer to the aircraft 15, it should be understood that this invention is applicable to a number of aerial vehicles.

The three reference axes 12, 14 and 16 may be considered as one corner and three sides of a cube. Ground reference elements 18 may move along the horizontal plane at a speed and direction proportional to the speed and direction of the ground relative to the aircraft 15 as measured by devices external to the instrument display. The size, shape, and color of the ground reference elements 18 may change with different altitude and ground speed. The ground reference elements 18 may be represented by geometric shapes or by an abstract representation of the ground surface.

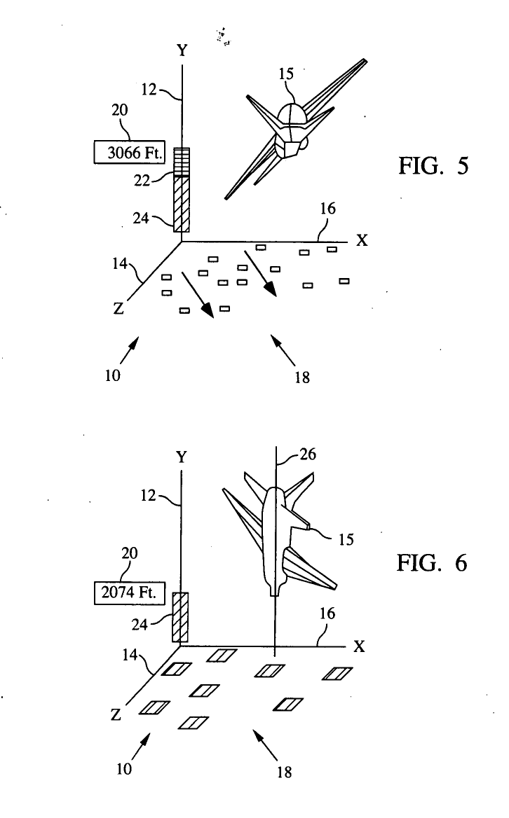

In this embodiment, a numeric altitude value display 20 may be in the proximity of a safe altitude reference element 22 and below a safe altitude reference element 24. One purpose of this numeric altitude value 20 is to provide the numeric value of the height of the aircraft 15 or aerial vehicle above ground or above sea level. Safe altitude reference element 22 and below-safe altitude reference element 24 may be represented by three-dimensional geometric shapes. These shapes may accumulate along the vertical axis, with the number of shapes being proportional to the altitude of the aircraft or aerial vehicle as measured by devices external to the instrument display 10. The shape and color of the safe altitude reference elements 22 and below-safe altitude reference elements 24 may be ways to distinguish whether the aircraft 15 is above or below a safe altitude. In FIGS. 1-7, the safe altitude reference 22 is shown as a number of horizontal lines, and the below safe altitude reference 24 is shown as 45° angle cross hatching.

An aircraft longitudinal axis element 26 is located along the longitudinal axis of the aircraft or aerial vehicle, and in this embodiment it extends both forward and aft of the aircraft model 15. The aircraft model 15 may be a three-dimensional representation of an aircraft or aerial vehicle and may be rotated in roll, pitch, or yaw according to the actual orientation of the aircraft or aerial vehicle relative to the earth as measured by devices external to the instrument display. The aircraft model 15 may be located in the center of the imaginary cube defined by the vertical axis reference 12, the depth axis reference 14, and the horizontal axis reference 16. In this embodiment, the aircraft model 15 is viewed from the rear and might use a fixed viewpoint relative to the three-axis reference.

FIG. 2 illustrates an instrument display 10 according to the present invention in a warning mode. In case a warning should be displayed, the vertical axis reference 12, the depth axis reference 14 and the horizontal axis reference 16 may change color or shape to warn the pilot or user of a potentially unsafe situation. For example, the numerical altitude value may change appearance or color in case of a warning. Ground reference elements 18 may change appearance or color in case of a warning. The aircraft longitudinal axis element 26 may change appearance or color if the pitch is negative or to warn the pilot or user of a potentially unsafe situation.

FIG. 3 illustrates the instrument display 10 according to the present invention where the aircraft 15 may have distinct top-side and bottom-side features. These features may be characterized by differences in color, texture or additional elements like under-wing marker elements 46. One purpose of these distinct top-side and bottom-side features is to enable the pilot or user to distinguish clearly when the aircraft 15 is inverted or partially inverted,

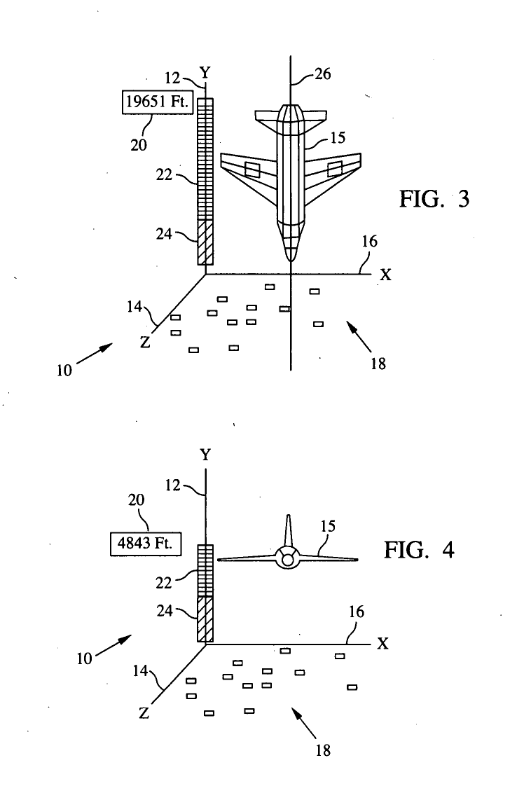

FIG. 4 illustrates the instrument display panel 10 representing an aircraft 15 (or other aerial vehicle) in level flight. The shape of the aircraft 15 may be characterized by the smallest possible silhouette for level flight.

Since current display design has inherited many poor design features through its historical roots, a new way for representing the major elements of flight dynamics is introduced. An object of the invention is to provide a unique, innovative way to display spatial information in flight instruments. The display is not designed to substitute for any of the traditional instruments. Rather, it supports the operator of an aircraft 15 in extreme or ambiguous situations by intuitively providing the appropriate level of spatial awareness.

To accomplish these goals, as many of the design guidelines, principles, and ideas for human-centered display design are implemented as are appropriate and pertinent. The main principle involved is to support the operator's mental model of the spatial behavior of the aircraft. The greatest challenge is to support the highest level of spatial awareness by projecting an immediate situation into the future.

The main design features are an exocentric design combined with pictorial metaphors of the current spatial orientation. By animating the entire scene, the instrument display tells a story about what happens during a flight maneuver. In this context the information displayed could be considered as a miniature abstract virtual world that represents the actual spatial situation of the aircraft.

In the instrument display 10 the aircraft 15 is represented by a 3D wire-frame model that hovers inside an abstracted box and replicates all the basic motions of a pilot's real aircraft. The frame of reference is a Cartesian coordinate system that includes X-, Y- and Z-axes. Altitude is represented by a three dimensional bar along the Y-axis. The aircraft's movement relative to the ground is displayed by moving objects along the X/Z plane. The overall display layout facilitates the implementation into Head Up Displays (HUDs) or Head Mounted Displays (HMDs). Principles of abstract and simplified symbology and restrictive uses of colors are applied.

The use of color is limited to red and green. In correspondence with color-coding design principles, green is used to show that the overall situation is not critical. Red is used for all warnings and critical conditions.

The instrument display 10 has three major moving parts: (1) the model of the aircraft 15, (2) the ground objects 18, and (3) the altitude bar 20. All movements are designed to support an operator's mental models. Every movement is intended to be natural and meaningful. Information is integrated to contribute to the complete situational picture, and every moving part is designed to be on the same level of abstraction.

The symbology of the present invention supports metaphors of real objects and conditions. The grade of abstraction depends on the level of abstraction in the real world. Therefore, the highest grade of abstraction is that of the spatial reference axis and the altitude. The lowest grade of abstraction is that of the model of the aircraft. However, the symbology for a certain fact or variable is designed to reflect each ones uniqueness so as to avoid misinterpretations. For instance, the ground may represented by squares, whereas the altitude is symbolized as half-transparent cubes.

To implement the exocentric design the invention uses an abstract system of three perpendicular axes. This is a common way to represent the three spatial axes; therefore, it supports intuitive understanding of this abstraction. The two main axes are the X- and Y-axes. The X-axis builds the reference for the roll parameters, and the Y-axis is a reference of the pitch angle. The Z-axis contributes to the depth impression of the scene. This system of axes builds an abstract box in which the aircraft 15 moves.

A visual angle of 55° is chosen as the field of view, which balances the need for a naturalistic look and the demand to make sufficient information available. The viewpoint is fixed from outside the virtual box.

There are two reasons for using an animated ground representation: first, without a ground representation, the aircraft model 15 appears to hover in space, which results in an artificial, unrealistic appearance. Second, the ground is an important plane of reference for the movement of the aircraft model 15. On the other hand, details of the ground terrain are not important. Therefore, the ground may be modeled by a number of objects of any selected shape such as squares, rectangles etc. The objects are generated at random positions and move against the main flight direction to maintain a high salience level. The ground objects 18 are displayed as frames so they will attract little attention when the altitude is not critical. When the altitude becomes critical, the ground objects 18 become solid. The overall impression from the display 10 is quite natural.

The aircraft model 15 is designed to support the discriminability of all the possible spatial orientations. The topside may have a green wire frame on a black background. The underside may have a black wire frame on a green background. Furthermore, the topside of the aircraft's body may be formed to have only longitudinal lines, whereas the underside has squares. At certain view angles, the green lines of the upper part will be seen in a way that makes the topside look very similar to the underside. To facilitate discriminability between the top and underside of the aircraft model 15 two rectangles are placed on the underside of the wings. The rectangles preferably have an easily seen color such as red.

The aircraft model 15 moves according to the pitch and roll of the real aircraft. The display has no built-in flight dynamics: it relies solely on input parameters from the hosting flight simulation or actual aircraft. Neither the yaw nor the heading is displayed, since the operator expects the nose of the aircraft to be in front of him. Instead, this invention implements the slip, which is a rotation around the Y-axis away from the main motion vector along the Z-axis. This movement occurs, for example, when crosswinds push the aircraft out of its orientation along the main heading direction. This implementation is consistent with the principles that support the operator's mental model of the spatial orientation and behavior of the aircraft.

The ground objects 18 move along the flight direction to simulate the relative ground speed. The greater the speed, the faster the ground objects 18 will move. The size of the objects changes with the altitude. The minimum size of the ground objects is preferably about 2 mm×2 mm. The maximum size preferably is about 10 mm×10 mm. The higher the altitude, the smaller the objects become. This supports the mental model of the operator, because when one looks down from a height, details on the ground become smaller as the height increases. The effect of shrinking object size induces the perception by the operator that, with higher altitude, the ground moves more slowly. When the aircraft starts a turn maneuver, the movement of the ground objects 18 changes in keeping with the direction of the turn. The ground objects 18 behave like ground details would behave in the same circumstances in the real world.

The altitude bar preferably comprises a stack of semitransparent cubes. This design feature ensures that the Y-axis is still recognizable as the vertical reference. If the pile of cubes were red, the altitude would be interpreted as unsafe. Green cubes represent a secure altitude. For every selected incremental increase in altitude a subsequent cube appears above the preceding one. For example, for military fighter and attack aircraft, the increment could be about 250 ft. For a small UAV an appropriate increment might be about 50 ft. The numerical value of the current altitude in feet is displayed parallel to the Y-axis.

Moving ground objects, the representation of the X-, Y-, and Z-axes, and the body of the aircraft are presented in green when the situation is not critical. The longitudinal axis of the aircraft is displayed in green when the pitch angle is positive (upwards); it is coded in red when the pitch angle is negative (downwards).

If the situation is critical, all elements of the scene turn a selected color, which is preferably red, except the aircraft model 15. An altitude below a selected safe value that depends on the type of aircraft. A critical altitude might be 2500 ft. for a large aircraft or 250 ft. for a small UAV. The red color-coding provides salient warning information and maintains the readability of the spatial information about the aircraft orientation. The ground objects have two stages during critical conditions. In the first stage, the frame of the objects turns red. In the second stage (for instance an altitude below 1500 ft.), the objects become solid red squares. This increases the salience of the objects. In combination with the growing size of the squares, this design provides an intense warning signal.

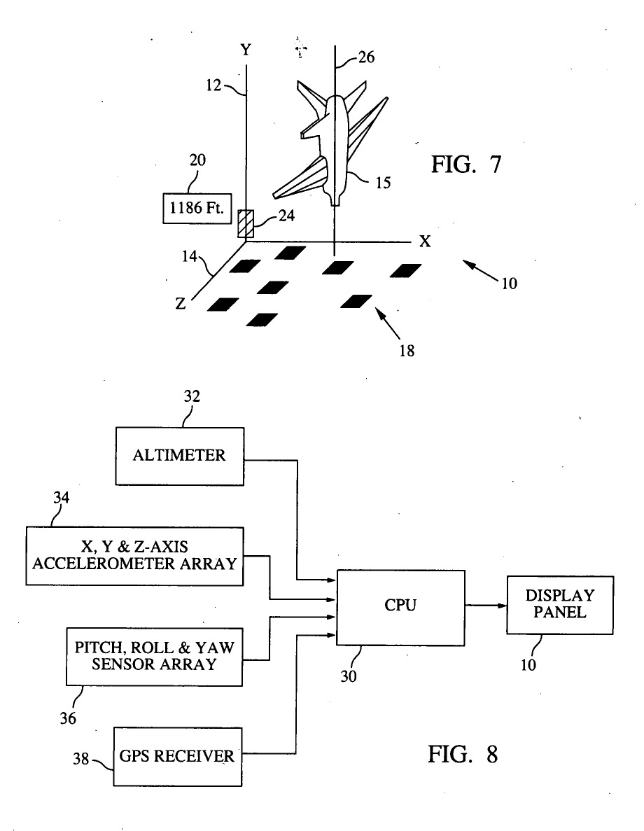

Referring to FIG. 8, the display panel 10 may be arranged to receive data to be displayed from a CPU 30. In a typical aircraft navigation system the CPU is arranged to receive signals from an altimeter 32, an accelerometer array 34, a rotation sensor array 36 and a GPS receiver 38. The CPU 30 processes the signals input thereto determine the location, heading, and velocity of the aircraft and provides signals to the display panel for display in the manner described above with reference to FIGS. 1-7.

To implement the proposed design idea, the graphics programming, network programming, and the complete project source code may be developed using the programming language C++ and compiled for Microsoft® Windows™ XP operating systems. The graphic application may be developed in the OpenGL® version 1.4 and the OpenGL Utility Toolkit (GLUT®), a graphic library for C++. The program may be developed and compiled using Microsoft® Visual Studio® version 7.1.3008.

The network sockets may be based on the Public Library PUB version 1.20 under the GNU Library General Public License, as published by the Free Software Foundation. All threads may be based on the open-source library OpenThreads, version 2.1, under the GNU Library General Public License, as published by the Free Software Foundation.

The graphics programming creates the spatial axes and the altitude indicator, integrates the aircraft model and animates it according to the transferred data of pitch, roll, and slip. Furthermore, the programming creates the flow of objects, determines the start coordinates, and provides data for the next movement. It also generates the numerical messages and displays and evaluates data for generating warnings and the maneuver time.

The aircraft model preferably comprises a topside and underside polygon model. These polygon models are assembled so that the topside and the underside of the aircraft look different in shape and color and avoid transparency (i.e., seeing through a wire-frame model).

The structures and methods disclosed herein illustrate the principles of the present invention. The invention may be embodied in other specific forms without departing from its spirit or essential characteristics. The described embodiments are to be considered in all respects as exemplary and illustrative rather than restrictive. Therefore, the appended claims rather than the foregoing description define the scope of the invention. All modifications to the embodiments described herein that come within the meaning and range of equivalence of the claims are embraced within the scope of the invention.

What is claimed is:

1. A method for displaying information to a pilot or operator of a manned or unmanned aerial vehicle to facilitate safe operation of the aerial vehicle, comprising the steps of:
providing a display screen;
displaying a three dimensional Cartesian coordinate system having a horizontal axis, a vertical axis and a depth axis on the display screen;
displaying a model of an aerial vehicle on the screen in a manner that represents the position and velocity of the aerial vehicle relative to the coordinate system;
displaying the horizontal axis and the vertical axis in a selected manner to indicate a potentially unsafe condition; and
providing an altitude display near the vertical axis.

2. The method of claim 1, further comprising the steps of:
providing a safe altitude reference element that gives a visual indication when the aerial vehicle is at a safe altitude; and
providing a below safe altitude reference element that gives a visual indication when the aerial vehicle is at an unsafe altitude.

3. The method of claim 1, further comprising the step of providing a plurality of ground objects in a horizontal plane that represent a portion of the earth over which the aerial vehicle is flying.

4. The method of claim 3 further comprising the step of moving the ground objects in the display in the horizontal plane at a speed and a direction that represent the speed and direction of the aerial vehicle relative to the earth.

5. The method of claim 4 further comprising the step of displaying the ground objects in a selected color when the aerial vehicle is below a selected safe altitude.

6. The method of claim 4 further comprising the step of displaying the ground objects to have dimensions that represent the altitude of the aerial vehicle.

7. The method of claim 1, further comprising the step of displaying a longitudinal axis line of the aerial vehicle in a first selected manner to indicate that the aerial vehicle has a positive pitch angle and displaying the longitudinal axis line in a second selected manner to indicate that the aerial vehicle has a negative pitch angle.

8. A system for displaying information to a pilot or operator of a manned or unmanned aerial vehicle to facilitate safe operation of the aerial vehicle, comprising:
a display screen;
a three dimensional Cartesian coordinate system having a horizontal axis, a vertical axis and a depth axis displayed on the display screen;
a model of an aerial vehicle displayed on the screen in a manner that represents the position and velocity of the aerial vehicle relative to the coordinate system; with the horizontal axis and the vertical axis being displayed in a selected manner to indicate a potentially unsafe condition; and
an altitude display near the vertical axis.

9. The system of claim 8, further comprising:
a safe altitude reference element on the vertical axis that gives a visual indication when the aerial vehicle is at a safe altitude; and
a below safe altitude reference element ton the vertical axis hat gives a visual indication when the aerial vehicle is at an unsafe altitude.

10. The system of claim 8, further comprising a plurality of ground objects in a horizontal plane that represent a portion of the earth over which the aerial vehicle is flying with the ground objects being arranged to move in the display in the horizontal plane at a speed and a direction that represent the speed and direction of the aerial vehicle relative to the earth.

11. The method of claim 8, further comprising a longitudinal axis line of the aerial vehicle displayed in a first selected manner to indicate that the aerial vehicle has a positive pitch angle and displayed in a second selected manner to indicate that the aerial vehicle has a negative pitch angle.
